(19) United States
(12) Patent Application Publication
(10) Pub. No.: US 2011/0181648 A1
(43) Pub. Date: Jul. 28, 2011

(54) IMAGE PRINTING METHOD AND IMAGE PRINTING DEVICE

(75) Inventor: Hideharu YONEOKA, Ibaraki-ken (JP)

(73) Assignee: RISO KAGAKU CORPORATION, Tokyo (JP)

(21) Appl. No.: 12/974,443

(22) Filed: Dec. 21, 2010

(30) Foreign Application Priority Data
Jan. 22, 2010 (JP) P2010-012402

(51) Int. Cl. B41J 2/205

(52) U.S. Cl. 347/15

(57) ABSTRACT

In an image printing method using an image printing device, a print mode of image data is set to a pure black print mode or a composite black print mode. If the pure black print mode is set, then a first monochrome processing is performed on the image data and first monochromatic image print data is generated, and a pure black printing is performed using a monochrome of K on the basis of the first monochromatic image print data. If the composite black print mode is set, then a second monochrome processing is performed on the image data, a color conversion process is performed on the image data, second monochromatic image print data is generated, and a composite black printing is performed using each color of CMYK based on the second monochromatic image print data.

### BACKGROUND OF THE INVENTION

1. Field of the Invention

The present invention relates to image printing methods and image printing devices, and in particular relates to a monochromatic image printing method in an image printing device having a color image printing function, and an image printing device for realizing this printing method.

2. Description of Related Art

In recent years, color printers have become increasingly popular both at home and in offices. The recent color printers are often complex machines having not only a print function but a facsimile function or a scanner function.

Usually, in a color printer, four color inks, i.e., a black (B or K) color in addition to three primary colors of cyan (C), magenta (M), and yellow (Y), are used. In particular, in an ink-jet color printer, a reduction in cost further accelerates its popularization. Japanese Patent Application Laid-open Publication No. H09-52390 discloses a printing method using a pure black and a printing method using a composite black as the black printing method, in the color ink-jet printer.

The printing method using a pure black is a method of printing with the use of only a black ink, and is suitable for printing an image, such as a text or a graphic, clearly defining the contour thereof. Moreover, because three primary color inks are not used in this printing method, the ink usage as the whole can be limited.

On the other hand, the printing method using a composite black is a method of expressing and printing black by overprinting a cyan ink, a magenta ink, and a yellow ink or by overprinting a black ink in addition to these three primary color inks. Because this printing method can express a red-tinged or blue-tinged black, this is suitable for printing a color photograph and the like.

### SUMMARY OF THE INVENTION

In the color ink-jet printer and its printing method disclosed in the above-described patent document, no consideration is taken as to separately using a pure black and a composite black while considering the ink usage (specifically, saving the ink usage) according to various types of image data (types of image information, such as a text, a graphic, and a photograph).

The present invention has been made to solve the above-described problems. It is an object of the present invention to provide an image printing method and image printing device capable of realizing a monochrome printing or gray scale printing corresponding to its printing purpose while suppressing the ink usage.

In order to solve the above-described problems, an image printing method according to a first aspect of the present invention comprises the steps of: determining whether or not image data is monochromatic image data; setting a print mode of the image data having been determined as the monochromatic image data to either a pure black print mode or a composite black print mode; if the pure black print mode is set, then performing a first monochrome processing on the image data to generate first monochromatic image print data; and performing a pure black printing with the use of a black monochrome based on the first monochromatic image print data; while if the composite black print mode is set, then performing a second monochrome processing on the image data, and performing a color conversion process on the image data subjected to this second monochrome processing, to generate second monochromatic image print data; and performing a composite black printing with the use of each color of cyan, magenta, yellow which are used in color printing and the black, based on the second monochromatic image print data.

An image printing device according to a second aspect of the present invention comprises: an image inputter for inputting image data; an image print data generator which generates color image print data and monochromatic image print data based on image data input to the image inputter; and a print section which performs a color printing and monochrome printing based on the color image print data and monochromatic image print data which are generated in the image print data generator, wherein the image print data generator comprises: an image data determinater which determines whether the input image data is color image data or monochromatic image data; a color image print data generator which performs a color conversion process on the image data having been determined as the color image data to generate color image print data; a black print mode setter which sets a print mode of the image data having been determined as the monochromatic image data to a pure black print mode or a composite black print mode; a first monochromatic image print data generator which, if the pure black print mode is set in the black print mode setter, performs a first monochrome processing on the monochromatic image data to generate first monochromatic image print data; and a second monochromatic image print data generator which, if the composite black print mode is set in the black print mode setter, and performs a second monochrome processing on the monochromatic image data, performs a color conversion process on the monochromatic image data subjected to this second monochrome processing, to generate second monochromatic image print data, and wherein the print section performs a color printing with the use of each color of cyan, magenta, yellow, and black based on the color image print data, performs a pure black printing with the use of the black monochrome based on the first monochromatic image print data, or performs a composite black printing with the use of each color of the cyan, the magenta, the yellow, and the black based on the second monochromatic image print data.

### BRIEF DESCRIPTION OF DRAWINGS

FIG. 1 is a system configuration diagram of an image printing device according to Embodiment 1 of the present invention.

FIG. 2 is a flow chart illustrating an image printing method according to Embodiment 1.

FIG. 3 is a view showing each color output conversion table of the image printing device according to Embodiment 1.

FIG. 4 is a system configuration diagram of an image printing device according to Embodiment 2 of the present invention.

FIG. 5 is a flow chart illustrating an image printing method according to Embodiment 2.

FIG. 6 is a view showing each color output conversion table of the image printing device according to Embodiment 2.

### DESCRIPTION OF EMBODIMENTS

Next, embodiments of the present invention will be described with reference to the accompanying drawings. In the following description of the drawings, the same or similar symbol is attached to the same or similar member. However, the drawings are schematically shown and differ from the real ones. Moreover, also between the drawings, there may be included differences in the sizes or ratios.

The embodiments shown below exemplify devices or methods for embodying technical ideas of the present invention, and the technical ideas of the present invention are not to be construed as limiting the arrangement and the like of the respective components to the following embodiments. The technical ideas of the present invention may be modified within the scope of the claims.

### Embodiment 1

Embodiment 1 of the present invention is an example of an image printing device as a complex machine having at least ink-jet printer function and scanner function and of an image printing method to which the present invention is applied.

### System Configuration of Image Printing Device

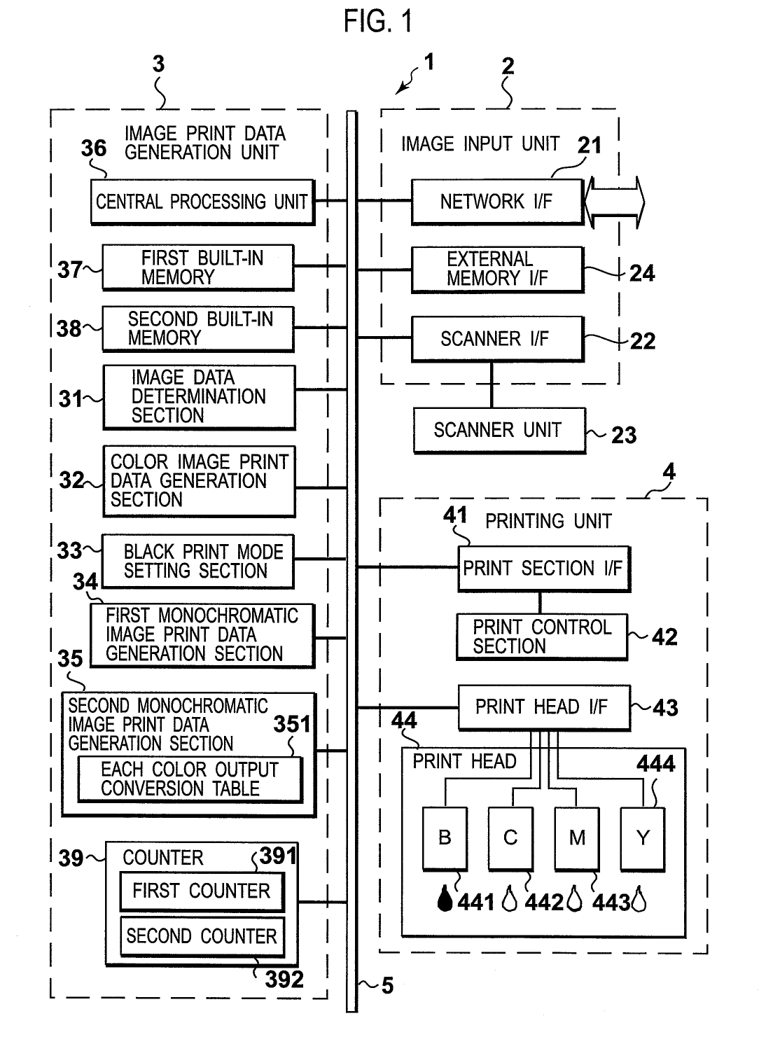

As shown in FIG. 1, an image printing device 1 according to Embodiment 1 comprises: an image input unit 2 for inputting image data; an image print data generation unit 3 which generates color image print data and monochromatic image print data based on image data input to the image input unit 2; and a printing unit 4 which performs a color printing and monochrome printing based on the color image print data and monochromatic image print data generated in the image print data generation unit 3. The image input unit 2, image print data generation unit 3, and printing unit 4 are coupled to each other through a data bus 5.

The image input unit 2 comprises a network interface 21 for inputting image data from the outside of the image printing device 1, a scanner interface 22 with a scanner function for constructing a complex machine, and an external memory interface 24 coupled to an external memory.

The network interface 21 is coupled to one or more terminals through transmission paths, such as a USB cable, a SCSI cable, an IEEE cable, a wired LAN, a wireless LAN, a telephone line, and a communication line. Here, the term “terminal” is used to mean a device, such as a personal computer or a portable terminal, capable of at least transmitting image data to the image printing device 1. The network interface 21 has a function to transmit data, such as the image data, which is transmitted through each of the scanner interface 22 and the external memory interface 24, to a terminal, and the image input unit 2 has a function as an image input/output unit capable of transmitting/receiving bidirectional data.

The scanner interface 22 is coupled to the scanner unit 23. The image data which has been input using the scanner unit 23 is output to the image print data generation unit 3 or a terminal through the scanner interface 22.

To the external memory interface 24, an external memory (storage medium) of the image printing device 1 can be coupled, and from this external memory at least image data can be output to the image print data generation unit 3 or the like through the external memory interface 24. Moreover, in the external memory interface 24, the data transmitted from a terminal through the network interface 21 can be stored in a memory, or the data stored in the memory can be transmitted to the terminal. This external memory includes at least either of a fixed mount type external memory, such as an optical disc for storing image data in a CD disc or a DVD disc, or a hard disc, or a portable type memory, such as a USB memory, or an SD card.

The image print data generation unit 3 comprises an image data determination section 31, a color image print data generation section 32, a black print mode setting section 33, a first monochromatic image print data generation section 34, a second monochromatic image print data generation section 35, and a counter 39. The image print data generation unit 3 further comprises a central processing unit (CPU) 36 performing the operation control, image data processing, and the like of the whole image printing device 1, a first internal memory 37, and a second internal memory 38. As the first internal memory 37, for example, a random access memory (RAM) capable of temporarily storing image data or program data, and reading this stored data, is used. As the second internal memory 38, for example, a hard disc (HDD) capable of storing a large quantity of data, such as image data or program data, and reading this stored data, is used.

The image data determination section 31 has a function to determine whether the image data having been input through the network interface 21 of the image input unit 2 is color image data or monochromatic image data. The color image print data generation section 32 has a function to perform a color conversion process on the image data having been input in the image data determination section 31 and having been determined as the color image data and generate color image print data. The black print mode setting section 33 has a function to set the print mode of image data having been input in the image data determination section 31 and having been determined as the monochromatic image data to either of a pure black print mode or a composite black print mode. This setting of the pure black print mode or composite black print mode can be arbitrarily performed by a user with the use of a non-illustrated operation panel of the image printing device 1 coupled to a print control section 42 of the printing unit 4. Moreover, this setting can be performed by a user through a transmission path from a terminal. Note that, in the descriptions of Embodiment 1 and subsequent Embodiment 2, etc., the term “monochromatic image data” is used in the sense that both the so-called “monochromatic image data” having the image data corresponding to white and the image data corresponding to black and the so-called “gray scale image data” including the image data corresponding to intermediate colors between black and white in addition to black and white are included.

The first monochromatic image print data generation section 34 has a function to perform, if the pure black print mode is set in the black print mode setting section 33, a first monochrome processing on monochromatic image data and generate first monochromatic image print data. The second monochromatic image print data generation section 35 has a function to perform, if the composite black print mode is set in the black print mode setting section 33, a second monochrome processing on monochromatic image data, perform a color conversion process on the monochromatic image data subjected to this second monochrome processing, and generate second monochromatic image print data.

The counter 39 comprises a first counter 391 and a second counter 392. Here, the first counter 391 has a function to count the number of executions of color printing which is transmitted through the data bus 5 from the printing unit 4. The number of executions of color printing is the number of sheets of A4-size paper, for example, on which the color printing has been executed. The second counter 392 has also a function to count the number of executions of pure black printing or composite black printing which is transmitted through the data bus 5 from the printing unit 4. Both the pure black printing and the composite black printing include the monochrome printing and gray scale printing, and the number of executions of these printings is the number of A4-size papers on which the black printing has been executed.

Note that, in the image printing device 1 according to Embodiment 1, the image print data generation unit 3 is configured in hardware, however, a part of the image print data generation unit 3 may be configured in software using the central processing unit 36 or the like.

The printing unit 4 comprises a print section interface 41, a print control section 42, a print head interface 43, and a print head 44. The print control section 42 is coupled to the data bus 5 through the print section interface 41. In the print control section 42, for example, the setting of the color printing or monochrome printing can be performed, and furthermore in the monochrome printing, the setting of the pure black printing or composite black printing can be performed. The print head 44 is coupled to the data bus 5 through the print head interface 43. In Embodiment 1, the print head 44 comprises four color print heads of a first print head 441 for printing (discharging) a pure black color, a second print head 442 for printing a cyan (C) color, a third print head 443 for printing a magenta (M) color, and a fourth print head 444 for printing a yellow (Y) color.

The printing unit 4 has a function to perform a color printing with the use of each color of cyan, magenta, yellow, and black based on color image print data. Furthermore, the printing unit 4 has a function to perform a pure black printing with the use of a black monochrome based on the first monochromatic image print data or perform a composite black printing with the use of each color of cyan, magenta, yellow, and black based on the second monochromatic image print data.

Note that, in the image printing device 1 according to Embodiment 1, the function of the black print mode setting section 32 of the image print data generation unit 3 can be given to the print control section 42 of the printing unit 4. In this case, the black print mode setting section 32 of the image print data generation unit 3 can be omitted.

### Image Printing Method

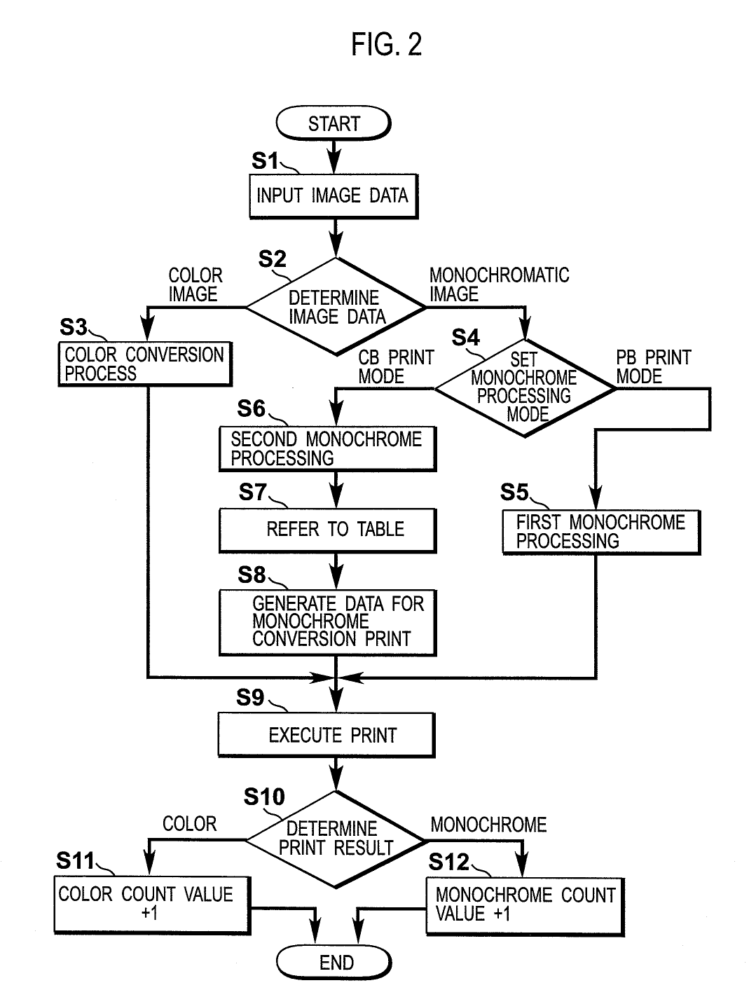

Next, an image printing method using the above-described image printing device 1 is executed in the following procedure, as shown in FIG. 2. In the description of this image printing method, each configuration of the image printing device 1 shown in FIG. 1 is referred to.

First, image data is input to the image printing device 1 (S1). The image data is created in a terminal, such as a personal computer. This image data is input to the image printing device 1 through a transmission path from the terminal, and is temporarily stored in the first internal memory 37 of the image print data generation unit 3 through the network interface 21 and data bus 5 of the image printing device 1 or is stored in the second internal memory 38. Moreover, the image data is generated in the scanner unit 23 of the image printing device 1, and is stored in the first internal memory 37 or second internal memory 38 through the scanner interface 22 and data bus 5. Moreover, the image data is created in a terminal or the like in advance, and this created image data can be stored in a portable type memory and this image data stored in the portable type memory can be stored in the first internal memory 37 or second internal memory 38 through the external memory interface 24 and data bus 5.

### (1) Color Printing Mode

The image data stored in the first internal memory 37 or second internal memory 38 is output to the image data determination section 31 in the image print data generation unit 3. In the image data determination section 31, it is determined whether the input image data is color image data or monochromatic image data (S2). Here, in Embodiment 1, the print setting of the image printing device 1 is as follows: if the image data is color image data, the color printing is automatically executed in a color printing mode, while if the image data is monochromatic image data, the monochrome printing is automatically executed in a monochrome printing mode.

If it is determined, in the image data determination section 31, that the image data is color image data, then this image data is output to the color image print data generation section 32. In the color image print data generation section 32, a color conversion process is performed on the color image data and color image print data is generated (S3). The color conversion process is a process to convert 8-bit (256 gradations) data representing red (R), green (G), or blue (B) to the binary data of cyan, magenta, yellow, or black and the data of the discharge amount of each color ink, for example.

The color image print data generated in the color image print data generation section 32 is output to the print head interface 43 of the printing unit 4 through the data bus 5. In the print head interface 43, ink discharging timings of the first print head 441 to the fourth print head 444 and their discharge amounts are controlled based on the color image print data, and the color printing is performed on an arbitrary sheet (S9).

Subsequently, it is determined whether the print result (printed document) is a color print or a monochrome print (S10). Here, the print result is determined as the color print and the number of color prints (number of printing times) is counted (S11). The counting of the number of color prints is performed by the first counter 391 of the counter 39. The count of the number of color prints is utilized in calculation of the charge corresponding to the number of color prints when the image printing device 1 is used as a rental, for example. Moreover, the determination whether or not the print result is a color print is made by using the color image print data which is output from the color image print data generation section 33 to the print head interface 43, for example. Upon completion of the counting of the number of color prints, the color printing of the image printing device 1 is completed.

### (2) Pure Black Print Mode

On the other hand, if the image data stored in the first internal memory 37 or second internal memory 38 of the image print data generation unit 3 is determined as the monochromatic image data (or gray scale image data) in the image data determination section 31 (S2), a user arbitrarily sets the pure black print mode or composite black print mode through the black print mode setting section 33 from an operation panel of a non-illustrated terminal or the image printing device 1 (S4).

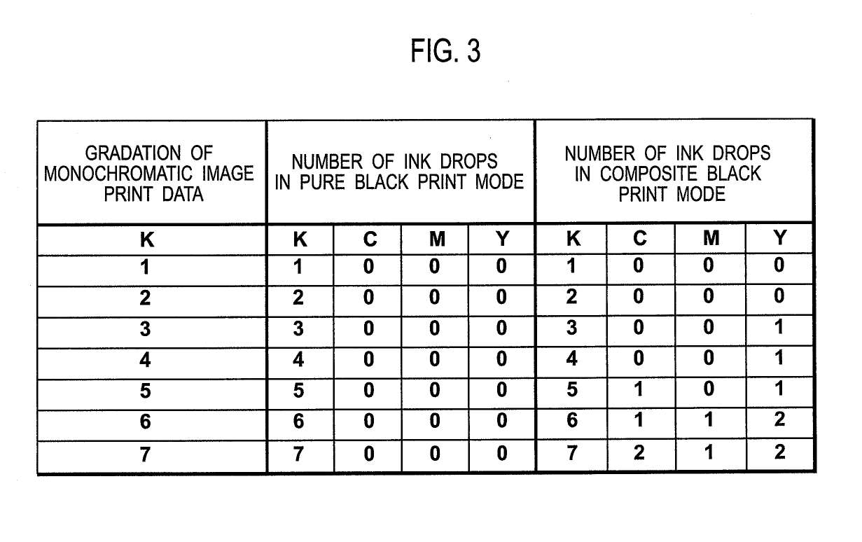

Here, when the monochromatic image data is the image data mainly comprising a text or a graphic, or the image data of a draft or not such an important photograph, if a user selects the pure black print mode in order to reduce the usage of an ink and suppress the running cost, the monochromatic image data is output to the first monochromatic image print data generation section 34. In the first monochromatic image print data generation section 34, the first monochrome conversion process (black monochrome conversion process) is performed on the monochromatic image data and the first monochromatic image print data is generated (S5). The first monochrome conversion process is a process to convert 8-bit (256 gradations) data representing red, green, or blue to the binary data of black and white and the data of the discharge amount of the black ink (see FIG. 3 described later), for example.

The first monochromatic image print data generated in the first monochromatic image print data generation section 34 is output to the print head interface 43 of the printing unit 4 through the data bus 5. In the print head interface 43, an ink discharging timing of only the first print head 441 and its discharge amount are controlled based on the first monochromatic image print data, and the pure black printing is performed on an arbitrary sheet (S9).

Subsequently, it is determined whether the print result (printed document) is a color print or a monochrome print (S10). Here, the print result is determined as the monochrome (pure black) print, and the number of monochrome prints (number of printing times) is counted (S12). The counting of the number of monochrome prints is performed by the second counter 392 of the counter 39. The count of the number of the monochrome prints is utilized in calculation of the charge corresponding to the number of monochrome prints when the image printing device 1 is used as a rental, for example. Moreover, the determination on whether or not the print result is the monochrome print is made using the first monochromatic image print data which is output from the first monochromatic image print data generation section 34 to the print head interface 43, for example. Upon completion of the counting of the number of monochrome prints, the monochrome printing of the image printing device 1 is completed.

### (3) Composite Black Print Mode

The image data stored in the first internal memory 37 or second internal memory 38 of the image print data generation unit 3 is determined as the monochromatic image data (or gray scale image data) in the image data determination section 31 (S2). If a user selects the composite black print mode through the black print mode setting section 33 from an operation panel of a non-illustrated terminal or the image printing device 1 (S4), the monochromatic image data is output to the second monochromatic image print data generation section 35. For example, when the monochromatic image data is a photograph, an illustration, or the like and a user wishes to express the depth or density of the black itself or express redness and blueness, the user can arbitrarily select the composite black print mode.

In the second monochromatic image print data generation section 35, the second monochrome conversion process (black monochrome conversion process) is performed on the monochromatic image data and the second monochromatic image print data is generated (S6). The second monochrome conversion process is basically the same as the first monochrome conversion process.

Furthermore, in the second monochromatic image print data generation section 35, the second monochrome conversion print data (monochrome conversion print data subjected to CMYK-conversion) for overprinting each ink of cyan, magenta, and yellow over the black ink is generated according to the composite black print mode. That is, a color conversion process to allocate the output ratio of each color of color inks to the black ink is performed according to the gray value (gradation number) of the second monochromatic image print data.

First, each color output conversion table 351 shown in FIG. 1 and FIG. 3 is referred to (S7). The each color output conversion table is the data having stored therein the output ratio of each color of cyan, magenta, yellow, and black corresponding to the gray value of the monochromatic image data (the second monochromatic image print data in Embodiment 1). In Embodiment 1, each color output conversion table 351 is incorporated into the second monochromatic image print data generation section 35.

In FIG. 3, the left portion shows the gradation of the monochromatic image print data. The gradation of the monochromatic image print data has seven levels here, and the gradation becomes denser from the number “1” toward “7”.

In FIG. 3, the center portion shows the number of ink drops corresponding to the gradation number of the first monochromatic image print data in the pure black print mode (black monochrome), i.e., in Step 5. In Embodiment 1, when the gradation number of the first monochromatic image print data is “1”, the number of black ink drops is “1”; when the gradation number is “2”, the number of black ink drops is “2”; . . . ; and when the gradation number is “7”, the number of black ink drops is “7”. That is, the number of ink drops in the pure black print mode varies corresponding to the gradation number which the first monochromatic image print data retains, and the number of ink drops increases as the gradation number of the first monochromatic image print data increases. Moreover, in the pure black print mode, each color ink of the cyan ink, magenta ink, and yellow ink is not used.

In FIG. 3, the right portion shows the number of ink drops in the composite black print mode. Although the composite black print mode is the same as the pure black print mode, here the right portion shows the number of ink drops corresponding to the gradation number of the second monochromatic image print data. In Embodiment 1, when the gradation number of the second monochromatic image print data is “1”, the number of black ink drops is “1” and the number of drops of each color ink of the cyan ink, magenta ink, and yellow ink is “0”. When the gradation number is “2”, the number of black ink drops is “2” and the number of drops of each color ink of the cyan ink, magenta ink, and yellow ink is “0”. When the gradation number is “3”, the number of black ink drops is “3” and the number of drops of the cyan ink and magenta ink is “0”, but the number of drops of the yellow ink is set to “1”. When the gradation number is “4”, the number of black ink drops is “4” and the number of drops of the cyan ink and magenta ink is “0”, but the number of drops of the yellow ink is set to “1”. When the gradation number is “5”, the number of black ink drops is “5” and the number of drops of the magenta ink is “0”, but the number of drops of the cyan ink and the yellow ink is set to “1”, respectively. When the gradation number is “6”, the number of black ink drops is “6”, the number of drops of the cyan ink is “1”, and the number of drops of the magenta ink is “1”, but the number of drops of the yellow ink is set to “2”. When the gradation number is “7”, the number of black ink drops is “7”, the number of drops of the cyan ink is “2”, and the number of drops of the magenta ink is “1”, but the number of drops of the yellow ink is set to “2”.

That is, the number of black ink drops and the number of color ink drops in the composite black print mode vary corresponding to the gradation number which the second monochromatic image print data retains, and the number of ink drops increases as the gradation number of the second monochromatic image print data increases. In Embodiment 1, the setting is made such that the number of drops of a color ink is increased little by little as the gradation number which the second monochromatic image print data retains increases. Here, the setting is made such that only the yellow ink is added in the gradation number “3” or “4” which is not such high, and as the gradation number increases to “5”, “6”, . . . , the cyan ink and magenta ink are sequentially added. The setting of the number of drops of the color ink is set in consideration of the magnitude of the influence of the gradient of black. The influence on the gradient of black decreases in the order of magenta, cyan, and yellow. When taking into consideration the influence on the gradient of black, the setting is not limited to this example. Moreover, the ratio of the number of drops of each color ink of cyan, magenta, and yellow can be set so as to vary according to the remaining amount of the ink. For example, when the remaining amount of the magenta ink is small, the adjustment can be made such that in the gradation number “6”, the cyan ink is used in place of the magenta ink and the magenta ink is used in the gradation number “7” in which the most accurate printing is requested. Such an adjustment can be easily realized by detecting the remaining amount of a color ink and changing the type of color ink using software based on this detection result.

Moreover, in the composite black print mode, the number of drops (ink usage) of a color ink is set to be small relative to the number of drops (ink usage) of the black ink, and therefore the running cost can be reduced as compared with the color printing mode.

Note that, in the image printing device 1 according to Embodiment 1, each color output conversion table 351 is incorporated into the second monochromatic image print data generation section 35, however, it may be stored in the second internal memory 38.

The second monochromatic image print data is converted into the second monochrome conversion print data for overprinting each color ink of cyan, magenta, and yellow over the black ink based on each color output conversion table shown in FIG. 3 (S8), in the second monochromatic image print data generation section 35.

The second monochrome conversion print data generated in the second monochromatic image print data generation section 35 is output to the print head interface 43 of the printing unit 4 through the data bus 5. In the print head interface 43, the composite black printing is performed on an arbitrary sheet by controlling the ink discharging timings of the first print head 441 to the fourth print head 444 and their discharge amounts based on the second monochrome conversion print data (S9).

Subsequently, it is determined whether the print result (printed document) is a color print or a monochrome print (S10). Here, the print result is determined as the monochrome (composite black) print, and the number of monochrome prints (number of printing times) is counted (S12). The counting of the number of monochrome prints is performed by the second counter 392 of the counter 39. Moreover, the determination on whether or not the print result is a monochrome print is made using the second monochrome conversion print data which is output from the second monochromatic image print data generation section 35 to the print head interface 43, for example. Upon completion of the counting of the number of monochrome prints, the monochrome printing of the image printing device 1 is completed.

### Features of Embodiment 1

In the image printing device 1 configured in this manner and the image printing method using the same, the image print data generation unit 3 is provided, and as the print mode of the monochrome printing or the gray scale printing, either the pure black print mode or the composite black print mode can be selected, and therefore, the monochrome printing or gray scale printing corresponding to its printing purpose can be realized while the ink usage is suppressed.

Furthermore, in the image printing device 1 and the image printing method using the same, the usage of the color inks of the composite black print mode is based on each color output conversion table shown in FIG. 3 and is relatively small as compared with the usage of the black ink, and therefore, the composite black printing can be realized while the usage of the color inks is further reduced. In addition, in the image printing device 1 and the image printing method using the same, the usage of the color inks of the composite black print mode is small and the composite black print mode can be charged as the monochrome printing (or gray scale printing), and therefore, the running cost on a user side can be reduced.

### Embodiment 2

Embodiment 2 of the present invention is an example having a function to save the usage of the color inks in the composite black print mode in the image printing device 1 and the image printing method using the same according to Embodiment 1.

### System Configuration of Image Printing Device

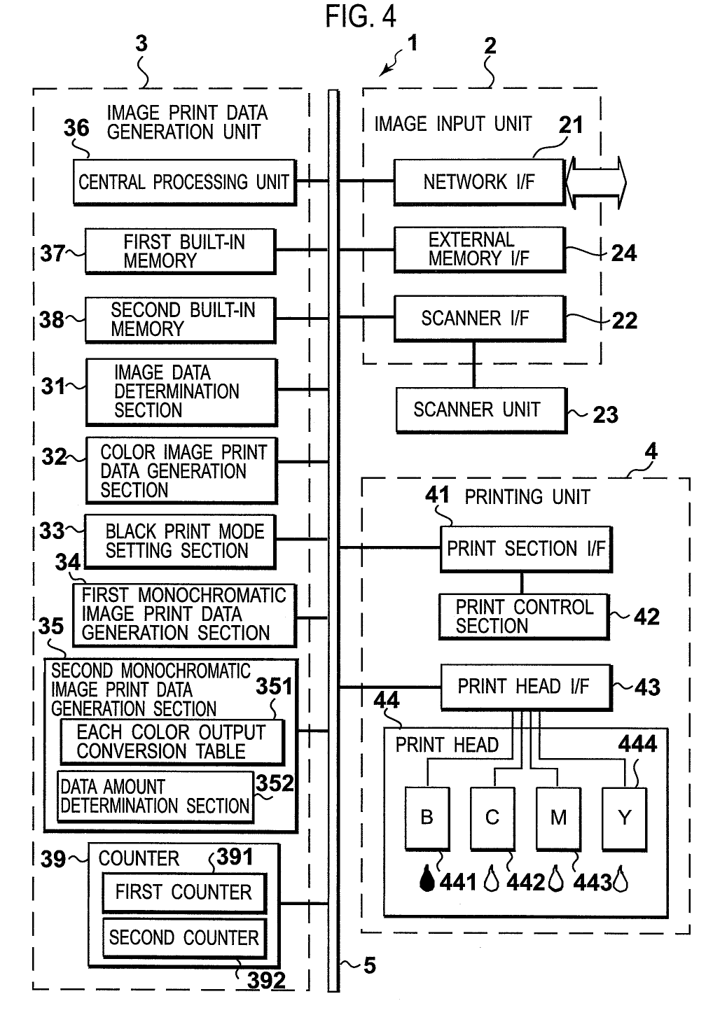

The image printing device 1 according to Embodiment 2 is basically the same as the image printing device 1 according to Embodiment 1 shown in FIG. 1. However, as shown in FIG. 4, the second monochromatic image print data generation section 35 of the image print data generation unit 3 comprises: each color output conversion table 351 having stored therein a wide variety of output ratios, wherein the output ratio of each color differs with respect to the same gradation of the second monochromatic image print data; and a data amount determination section 352 which determines whether the data amount of the second monochromatic image print data is large or small.

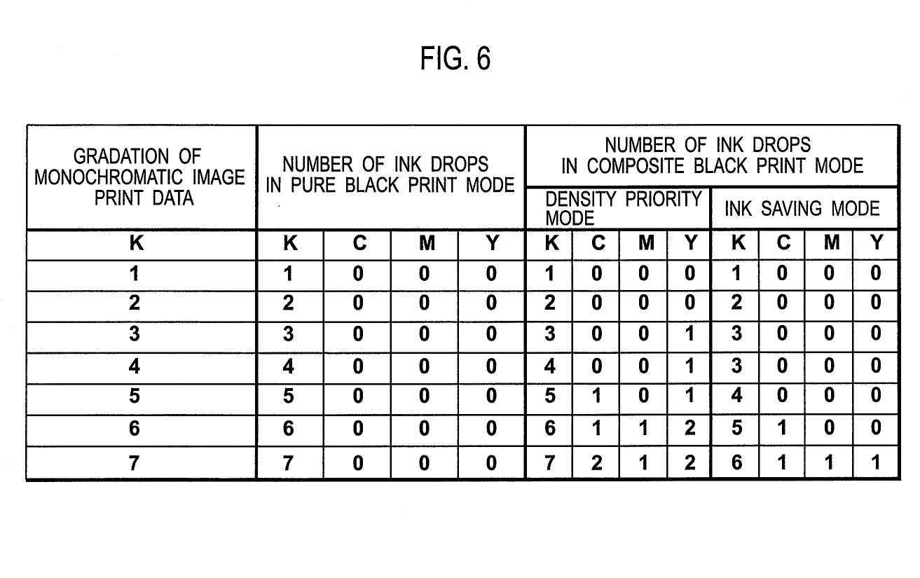

As shown in FIG. 6, each color output conversion table 351 includes two types of output ratios used for a density priority mode and an ink saving mode in the composite black print mode. In this view, the number of ink drops of the pure black print mode is also provided for comparison.

In the density priority mode, the output ratio is set as with the output ratio stored in each color output conversion table 351 of the image printing device 1 according to Embodiment 1, here. That is, when the gradation number of the second monochromatic image print data is “1”, the number of black ink drops is “1” and the number of drops of each color ink of the cyan ink, magenta ink, and yellow ink is “0”. When the gradation number is “2”, the number of black ink drops is “2” and the number of drops of each color ink of the cyan ink, magenta ink, and yellow ink is “0”. When the gradation number is “3”, the number of black ink drops is “3” and the number of drops of the cyan ink and magenta ink is “0”, but the number of drops of the yellow ink is set to “1”. When the gradation number is “4”, the number of black ink drops is “4” and the number of drops of the cyan ink and magenta ink is “0”, but the number of drops of the yellow ink is set to “1”. When the gradation number is “5”, the number of black ink drops is “5” and the number of drops of the magenta ink is “0” but the number of drops of the cyan ink and the yellow ink is set to “1”, respectively. When the gradation number is “6”, the number of black ink drops is “6”, the number of drops of the cyan ink is “1”, and the number of drops of the magenta ink is “1”, but the number of drops of the yellow ink is set to “2”. When the gradation number is “7”, the number of black ink drops is “7”, the number of drops of the cyan ink is “2”, and the number of drops of the magenta ink is “1”, but the number of drops of the yellow ink is set to “2”.

In the ink saving mode, the ink usage is set low as a whole relative to that in the density priority mode. That is, when the gradation number of the second monochromatic image print data is “1” to “3”, the number of black ink drops is “1” to “3” and the number of drops of each color ink of the cyan ink, magenta ink, and yellow ink is “0”. When the gradation number is “4”, the number of black ink drops is reduced to “3” and saved and the number of drops of each color ink of the cyan ink, magenta ink, and yellow ink is “0”. When the gradation number is “5”, the number of black ink drops is reduced to “4” and saved and the number of drops of the cyan ink and magenta ink is “0”. When the gradation number is “6”, the number of black ink drops is reduced to “5” and saved and the number of drops of the magenta ink and yellow ink is “0”, respectively, but the number of drops of the cyan ink is set to “1”. When the gradation number is “7”, the number of black ink drops is reduced to “6” and saved and the number of drops of the magenta ink, cyan ink, and the yellow ink is set to “1”, respectively.

The data amount determination section 352, for example, with respect to the data amount of the second monochromatic image print data within one page print range, automatically determines whether the data amount is large or small based on a predetermined threshold value, and if the data amount is small, the density priority mode is selected while if the data amount is large, the ink saving mode is selected. Note that this mode selection may be set such that a user side can switch the mode. Moreover, each color output conversion table may include at least one intermediate mode between the density priority mode and the ink saving mode. Moreover, it is also possible to cause the central processing unit 36 of the image print data generation unit 3 to perform the function of the data amount determination section 352. Furthermore, the predetermined threshold value may be a constant value, but may be varied according to the remaining amount of an ink. For example, if the number of drops of the color ink is reduced when the remaining amount of a color ink has decreased, the usage of the color ink can be saved. Moreover, the predetermined threshold value may be set separately in each of the color ink and the black ink.

### Image Printing Method

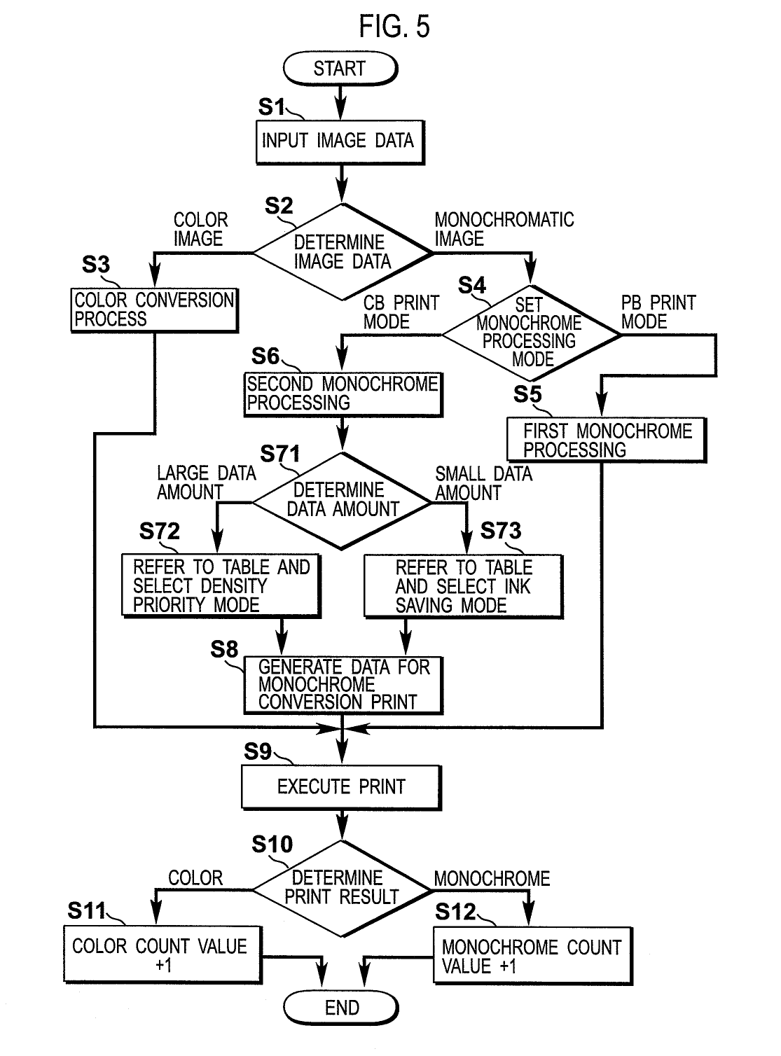

Next, the image printing method using the above-described image printing device 1 is executed in the following procedure, as shown in FIG. 5. In the description of this image printing method, each configuration of the image printing device 1 shown in FIG. 4 is referred to. Moreover, in the image printing method according to Embodiment 2, only a difference from the image printing method according to Embodiment 1, i.e., the composite black print mode, is described.

In the image printing method using the image printing device 1 according to Embodiment 2, the image data stored in the first internal memory 37 or second internal memory 38 of the image print data generation unit 3 is determined as monochromatic image data (or gray scale image data) in the image data determination section 31 (S2). If a user selects the composite black print mode through the black print mode setting section 33 from an operation panel of a non-illustrated terminal or the image printing device 1 (S4), the monochromatic image data is output to the second monochromatic image print data generation section 35. When the monochromatic image data is a photograph, an illustration, or the like and when a user wishes to express the depth or density of the black itself, the user can arbitrarily select the composite black print mode.

In the second monochromatic image print data generation section 35, the second monochrome conversion process (black monochrome conversion process) is performed on the monochromatic image data and the second monochromatic image print data is generated (S6). The second monochrome conversion process is basically the same as the first monochrome conversion process.

In the data amount determination section 352 of the second monochromatic image print data generation section 35, it is determined whether the data amount of the second monochromatic image print data within one page of A4 size is large or small (S71). If the data amount of the second monochromatic image print data is small, the density priority mode in which the output ratio of each color of each color output conversion table 351 is large is selected (S72), and the color conversion process to allocate the output ratio of each color of color inks to the black ink is performed according to the gray value of the second monochromatic image print data, and the second monochrome conversion print data is generated (S8). Moreover, if the data amount of the second monochromatic image print data is large, the ink saving mode in which the output ratio of each color of each color output conversion table 351 is small is selected (S73), and the color conversion process to allocate the output ratio of each color of color inks to the black ink is performed according to the gray value of the second monochromatic image print data, and the second monochrome conversion print data is generated (S8).

The second monochrome conversion print data generated in the second monochromatic image print data generation section 35 is output to the print head interface 43 of the printing unit 4 through the data bus 5. In the print head interface 43, the composite black printing is performed on an arbitrary sheet by controlling the ink discharging timings and their discharge amounts of the first print head 441 to the fourth print head 444 based on the second monochrome conversion print data (S9).

Subsequently, it is determined whether the print result (printed document) is a color print or a monochrome print (S10). Here, the print result is determined as the monochrome (composite black) print, and the number of monochrome prints (number of printing times) is counted (S12). The counting of the number of monochrome prints is performed by the second counter 392 of the counter 39. Moreover, the determination on whether or not the print result is a monochrome print is made using the second monochrome conversion print data which is output from the second monochromatic image print data generation section 35 to the print head interface 43, for example. Upon completion of the counting of the number of monochrome prints, the monochrome printing of the image printing device 1 is completed.

### Features of Embodiment 2

In the image printing device 1 configured in this manner and the image printing method using the same, the same effect as that obtained by the image printing device 1 and the image printing method using the same according to Embodiment 1 can be obtained. Furthermore, in the image printing device 1, the second monochromatic image print data generation section 35 of the image print data generation unit 3 comprises: each color output conversion table 351 having stored therein a wide variety of output ratios, wherein the output ratio of each color differs; and the data amount determination section 352 which determines whether the data amount of the second monochromatic image print data is large or small, wherein the usage of each color ink is adjusted according to the data amount of the second monochromatic image print data. Accordingly, the monochrome printing or gray scale printing corresponding to its printing purpose can be realized while the ink usage is suppressed.

### OTHER EMBODIMENTS

As described above, the present invention has been described using Embodiment 1 and Embodiment 2, however, the statements and drawings which are a part of the present disclosure are not to be construed as limiting the present invention. The present invention can be applied to various kinds of alternative embodiments, embodiments, and operation technologies. For example, in the above-described embodiments, an example of applying the present invention to the ink-jet printer as the image printing device 1 has been described, however, the present invention can be applied to a laser beam printer capable of performing a color printing with the use of each color toner.

In this manner, the present invention can be widely applied to an image printing device which performs a monochrome printing or gray scale printing corresponding to its printing purpose while suppressing the ink usage, and an image printing method using the same.

The present application is based upon and claims the benefit of priority under 35 U.S.C. §119 to Japanese Patent Applications No. 2010-012402, filed on Jan. 22, 2010, the entire content of which is incorporated herein by reference.

What is claimed is:

1. An image printing method comprising:
determining whether or not image data is monochromatic image data;
setting a print mode of the image data having been determined as the monochromatic image data to either a pure black print mode or a composite black print mode;
if the pure black print mode is set,
then performing a first monochrome processing on the image data to generate first monochromatic image print data; and
performing a pure black printing with the use of a black monochrome on the basis of the first monochromatic image print data; while
if the composite black print mode is set,
then performing a second monochrome processing on the image data, and performing a color conversion process on the image data subjected to this second monochrome processing, to generate second monochromatic image print data; and
performing a composite black printing with the use of each color of cyan, magenta, yellow which are used in color printing and the black, on the basis of the second monochromatic image print data.

2. The image printing method according to claim 1, wherein with the use of at least one color output conversion table having stored therein an output ratio of each color of the cyan, the magenta, the yellow, and the black corresponding to a gray value of the monochromatic image data, the second monochromatic image print data is generated by performing a color conversion process in which the output ratio of each color is allocated according to a gray value of the image data subjected to the second monochrome processing.

3. The image printing method according to claim 2, wherein the second monochromatic image print data is generated by performing a color conversion process on the monochromatic image data by changing an output ratio of each color with the use of a plurality of color output conversion tables in which an output ratio of each color differs.

4. The image printing method according to claim 3, wherein the second monochromatic image print data is generated by, in accordance with a data amount of the monochromatic image data,
selecting a color output conversion table, in which an output ratio of each color is small, from among the plurality of color output conversion tables if the data amount is large,
selecting a color output conversion table, in which an output ratio of each color is large, from among the plurality of color output conversion tables if the data amount is small, and
performing a color conversion process on the monochromatic image data using the selected color output conversion table.

5. The image printing method according to claim 2, wherein in the at least one color output conversion table, the respective output ratios of the cyan, the magenta, and the yellow are set to smaller values, respectively, than a value of an output ratio of the black.

6. An image printing device comprising:
an image inputter for inputting image data;
an image print data generator which generates color image print data and monochromatic image print data on the basis of image data input to the image inputter; and
a print section which performs a color printing and monochrome printing on the basis of the color image print data and monochromatic image print data which are generated in the image print data generator, wherein
the image print data generator comprises:
an image data determinater which determines whether the input image data is color image data or monochromatic image data;
a color image print data generator which performs a color conversion process on the image data having been determined as the color image data to generate color image print data;
a black print mode setter which sets a print mode of the image data having been determined as the monochromatic image data to a pure black print mode or a composite black print mode;
a first monochromatic image print data generator which, if the pure black print mode is set in the black print mode setter, performs a first monochrome processing on the monochromatic image data to generate first monochromatic image print data; and
a second monochromatic image print data generator which, if the composite black print mode is set in the black print mode setter, and performs a second monochrome processing on the monochromatic image data, performs a color conversion process on the monochromatic image data subjected to this second monochrome processing, to generate second monochromatic image print data, and wherein
the print section performs a color printing with the use of each color of cyan, magenta, yellow, and black on the basis of the color image print data, performs a pure black printing with the use of the black monochrome on the basis of the first monochromatic image print data, or performs a composite black printing with the use of each color of the cyan, the magenta, the yellow, and the black on the basis of the second monochromatic image print data.

7. The image printing device according to claim 6, wherein the second monochromatic image print data generator, with the use of at least one color output conversion table having stored therein an output ratio of each color of the cyan, the magenta, the yellow, and the black corresponding to a gray value of the monochromatic image data, performs a color conversion process in which an output ratio of each color is allocated according to a gray value of the image data subjected to the second monochrome processing to generate the second monochromatic image print data.

8. The image printing device according to claim 7, wherein the second monochromatic image print data generator, with the use of a plurality of color output conversion tables in which an output ratio of each color differs, performs a color conversion process on the monochromatic image data by changing an output ratio of each color to generate the second monochromatic image print data.

9. The image printing device according to claim 8, wherein the second monochromatic image print data generator, according to a data amount of the monochromatic image data, selects a color output conversion table in which an output ratio of each color is small, from among the plurality of color output conversion tables if the data amount is large, selects a color output conversion table in which an output ratio of each color is large, from among the plurality of color output conversion tables if the data amount is small, and performs a color conversion process on the monochromatic image data using the selected color output conversion table to generate the second monochromatic image print data.

10. The image printing device according to claim 7, wherein in the at least one color output conversion table, the respective output ratios of the cyan, the magenta, and the yellow are set to smaller values than a value of an output ratio of the black.
